(19) United States
(12) Patent Application Publication
(10) Pub. No.: US 2022/0383382 A1
(43) Pub. Date: Dec. 1, 2022

(54) PRODUCT INFORMATION PROCESSING SYSTEM, PRODUCT INFORMATION PROCESSING METHOD, AND RECORDING MEDIUM

(71) Applicant: RAKUTEN GROUP, INC., Tokyo (JP)

(72) Inventor: Teruyuki SHITARA, Tokyo (JP)

(73) Assignee: RAKUTEN GROUP, INC., Tokyo (JP)

(21) Appl. No.: 17/751,065

(22) Filed: May 23, 2022

(30) Foreign Application Priority Data
May 26, 2021 (JP) 2021-088302

(51) Int. Cl. G06Q 30/06; G06V 10/22; G06V 10/74

(52) U.S. Cl. CPC G06Q 30/0625; G06V 10/22; G06V 10/761

(57) ABSTRACT

Provided is a product information processing system for facilitating registration of appropriate similar items in a post related to items. A determination receiver receives determination of one item among at least one candidate item having been selected to present details. The register registers a post containing a photo image in association with at least one candidate item, item information, and sales information on the item of which determination is received. When no sales information is associated with the registered post, or when sales information is associated with the post but the item indicated by the sales information is sold out on the e-commerce website, the similarity search result retriever retrieves a similarity search result through similarity searching in items now being sold on the e-commerce website on the basis of the at least one candidate item and the item information. The publisher publishes the post and sales information on items contained in the similarity search result.

### CROSS-REFERENCE TO RELATED APPLICATION

This application claims the benefit of Japanese Patent Application No. 2021-088302, filed on May 26, 2021, the entire disclosure of which is incorporated by reference herein.

### FIELD

This application relates to a product information processing system, a product information processing method, and a recording medium.

### BACKGROUND

Users have been making posts containing pictures of items taken by the users in a social networking service (SNS), as well as comments on the items and the like. For example, Non-Patent Literature 1 (https://netshop.impress.co.jp/node/7982) discloses a technique that allows shoppers and merchants of an e-commerce website to make and publish posts containing fashion coordinate images and information on items included in the fashion coordinate images.

### SUMMARY

In the above-mentioned technique, a user who is going to make a post is required to register the post such that an item included in the image is associated with an item available on the e-commerce website. Unfortunately, the user may fail in this association after searching on the e-commerce website in some cases because the item that the user is going to post is unavailable on the e-commerce website. In other cases, the e-commerce website may stop selling the item associated by the user because the item is sold out, for example. In these cases, the item included in the image is preferably associated with similar items similar to the item and now being sold on the e-commerce website, but it is difficult for the user to register appropriate similar items without increasing the burden on the user.

An objective of the present disclosure, which has been accomplished as a solution to the above problem, is to provide a product information processing system, a product information processing method, and a recording medium that can facilitate registration of appropriate similar items in a post related to an item.

A product information processing system according to a first aspect of the present disclosure includes: at least one memory that stores program code; and at least one processor configured to read the program code and operate in accordance with the program code. The program code includes: photo image reception code configured to cause the at least one processor to receive a photo image that captures an item from a poster; extraction code configured to cause the at least one processor to extract an area, in which an item of a predetermined type is depicted, from the received photo image; item information acquisition code configured to cause the at least one processor to acquire item information on the item depicted in the extracted area by guiding the poster to input the item information; match search result retrieval code configured to cause the at least one processor to retrieve a match search result through match searching in items being sold on an e-commerce website a match search condition including the acquired item information; relaxed search result retrieval code configured to cause the at least one processor to generate a relaxed search condition by relaxing the match search conditions, and retrieve a relaxed search result through match searching in the items being sold on the e-commerce website on basis of the generated relaxed search condition; first presentation code configured to cause the at least one processor to present a list, in which items contained in the retrieved match search result are arranged prior to items contained in the retrieved relaxed search result, to the poster; first selection reception code configured to cause the at least one processor to receive, from the poster, selection of at least one candidate item from the items contained in the list; second presentation code configured to cause the at least one processor to present details of the selected at least one candidate item to the poster; determination reception code configured to cause the at least one processor to receive, from the poster, determination of any one item among the at least one candidate item that has been selected to present the details; registration code configured to cause the at least one processor to register a post containing the received photo image in association with (i) the at least one candidate item that has been selected and of which the details are viewed by the poster and (ii) the acquired item information, the registration code being configured to cause, when the at least one processor according to the determination reception code receives the determination of any one item from the poster, the at least one processor to register sales information on the item of which the determination is received in association with the post; publication code configured to cause the at least one processor to publish the registered post; and similarity search result retrieval code. When no sales information is associated with the registered post, or when sales information is associated with the registered post but an item indicated by the sales information is sold out on the e-commerce website, the similarity search result retrieval code is configured to cause the at least one processor to retrieve a similarity search result through similarity searching in the items now being sold on the e-commerce website on the basis of the registered at least one candidate item and the registered item information, and the publication code is configured to cause the at least one processor to publish sales information on an item contained in the retrieved similarity search result as well as the post.

In the product information processing system according to the first aspect, the item information acquisition code is configured to cause the at least one processor to acquire the item information by guiding the poster to select one of multiple predetermined options and input a text, and the relaxed search result retrieval code is configured to cause the at least one processor to generate the relaxed search condition by relaxing a search condition related to the selected option of the match search condition.

In the product information processing system according to the first aspect, the similarity search result retrieval code is configured to cause the at least one processor to remove information on the selected option from the registered item information and then execute similarity searching.

In the product information processing system according to the first aspect, the similarity search result retrieval code is configured to cause the at least one processor to add information on an option similar to the selected option to the registered item information and then execute similarity searching.

In the product information processing system according to the first aspect, the program code further contains: third presentation code configured to cause the at least one processor to present, to the poster, a catalog of the at least one candidate item that has been selected to present the details, when the at least one processor according to the determination reception code receives no determination of any one item from the poster; and second selection reception code configured to cause the at least one processor to receive, from the poster, selection of an item different from the item depicted in the area among the at least one candidate item contained in the catalog. The similarity search result retrieval code is configured to cause the at least one processor to remove the selected different item from the registered at least one candidate item and then execute similarity searching.

In the product information processing system according to the first aspect, the program code further contains: third presentation code configured to cause the at least one processor to present, to the poster, a catalog of the at least one candidate item that has been selected to present the details, when the at least one processor according to the determination reception code receives no determination of any one item from the poster; and third selection reception code configured to cause the at least one processor to receive, from the poster, selection of an item similar to the item depicted in the area among the at least one candidate item contained in the catalog. The similarity search result retrieval code is configured to cause the at least one processor to execute similarity searching on the basis of the selected similar item instead of the registered at least one candidate item.

In the product information processing system according to the first aspect, the similarity search result retrieval code is configured to cause the at least one processor to execute similarity searching further on the basis of an image of the area extracted from the photo image and a photo image of the registered candidate item.

A product information processing method according to a second aspect of the present disclosure, which is executed in a product information processing system, involves: receiving a photo image that captures an item from a poster; extracting an area, in which an item of a predetermined type is depicted, from the received photo image; acquiring item information on the item depicted in the extracted area by guiding the poster to input the item information; retrieving a match search result through match searching in items being sold on an e-commerce website on basis of a match search condition including the acquired item information; generating a relaxed search condition by relaxing the match search conditions, and retrieving a relaxed search result through match searching in the items being sold on the e-commerce website on basis of the generated relaxed search condition; presenting a list, in which items contained in the retrieved match search result are arranged prior to items contained in the retrieved relaxed search result, to the poster; receiving, from the poster, selection of at least one candidate item from the items contained in the list; presenting details of the selected at least one candidate item to the poster; receiving, from the poster, determination of any one item among the at least one candidate item that has been selected to present the details; registering a post containing the received photo image in association with (i) the at least one candidate item that has been selected and of which the details are viewed by the poster and (ii) the acquired item information, and when receiving the determination of any one item from the poster, registering sales information on the item of which the determination is received in association with the post; and publishing the registered post, in the product information processing system. When no sales information is associated with the registered post, or when sales information is associated with the registered post but an item indicated by the sales information is sold out on the e-commerce website, the product information processing system retrieves a similarity search result through similarity searching in the items now being sold on the e-commerce website on the basis of the registered at least one candidate item and the registered item information, and publishes sales information on an item contained in the retrieved similarity search result as well as the post.

A recording medium storing a program according to a third aspect of the present disclosure is configured to cause a computer to: receive a photo image that captures an item from a poster; extract an area, in which an item of a predetermined type is depicted, from the received photo image; acquire item information on the item depicted in the extracted area by guiding the poster to input the item information; retrieve a match search result through match searching in items being sold on an e-commerce website on basis of a match search condition including the acquired item information; generate a relaxed search condition by relaxing the match search condition, and retrieve a relaxed search result through match searching in the items being sold on the e-commerce website on basis of the generated relaxed search condition; present a list, in which items contained in the retrieved match search result are arranged prior to items contained in the retrieved relaxed search result, to the poster; receive, from the poster, selection of at least one candidate item from the items contained in the list; present details of the selected at least one candidate item to the poster; receive, from the poster, determination of any one item among the at least one candidate item that has been selected to present the details; register a post containing the received photo image in association with (i) the at least one candidate item that has been selected and of which the details are viewed by the poster and (ii) the acquired item information, and when receiving the determination of any one item from the poster, register sales information on the item of which the determination is received in association with the post; and publish the registered post. When no sales information is associated with the registered post, or when sales information is associated with the registered post but an item indicated by the sales information is sold out on the e-commerce website, the program causes the computer to retrieve a similarity search result through similarity searching in the items now being sold on the e-commerce website on the basis of the registered at least one candidate item and the registered item information, and publish sales information on an item contained in the retrieved similarity search result as well as the post.

The above-described non-transitory recording medium can be distributed and sold independently from a computer. This non-transitory recording medium indicates a tangible recording medium. Examples of the non-transitory recording medium include compact disk, flexible disk, hard disk, magneto optical disk, digital video disk, magnetic tape, and semiconductor memory. In contrast, a transitory recording medium indicates a transmission medium (propagating signal) itself. Examples of the transitory recording medium include electrical signal, optical signal, and electromagnetic wave. A temporary storage area indicates an area for temporarily storing data and program. A typical example of the temporary storage area is a volatile memory, such as random access memory (RAM).

The present disclosure can provide a product information processing system, a product information processing method, and a recording medium that can facilitate registration of appropriate similar items in a post related to an item.

### BRIEF DESCRIPTION OF THE DRAWINGS

A more complete understanding of this application can be obtained when the following detailed description is considered in conjunction with the following drawings, in which:

FIG. 1 illustrates a relationship among a product information processing system according to an embodiment, a poster terminal, a viewer terminal, and an e-commerce server;

FIG. 2 illustrates a hardware configuration of a server for achieving the product information processing system according to the embodiment;

FIG. 3 illustrates a functional configuration of the product information processing system according to the embodiment;

FIG. 4 illustrates a screen for uploading of a photo image according to the embodiment;

FIG. 5 is a diagram for describing extracted areas according to the embodiment;

FIG. 6 is a diagram for describing an image for input of item information according to the embodiment;

FIG. 7 is a diagram for describing a list according to the embodiment;

FIG. 8 illustrates a screen for presentation of the details of candidate items according to the embodiment;

FIG. 9 illustrates a screen for displaying an exemplary published post according to the embodiment;

FIG. 10 illustrates a screen for displaying another exemplary published post according to the embodiment;

FIG. 11 is a flowchart for describing product information processing according to the embodiment;

FIG. 12 illustrates a functional configuration of a product information processing system according to a modification; and

FIG. 13 is a diagram for describing a catalog according to the modification.

### DETAILED DESCRIPTION

1. Entire Configuration

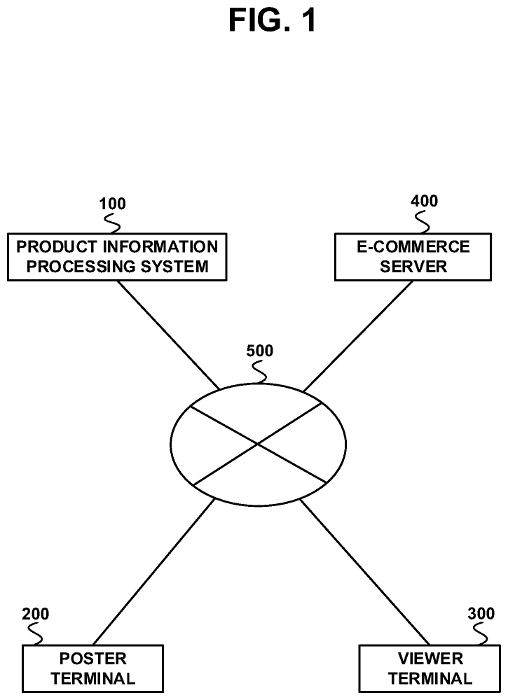

As illustrated in FIG. 1, a product information processing system 100 according to an embodiment of the present disclosure is connected to a poster terminal 200, a viewer terminal 300, and an e-commerce server 400 via a network 500 so as to be communicable with each other.

The product information processing system 100 receives a post related to items from a user and publishes the post. The product information processing system 100 also allows another user viewing the post to buy the items contained in the post on an e-commerce website. For example, the product information processing system 100 is aimed at operating and managing a shopping SNS that handles information on items to be sold and bought on the e-commerce website.

The product information processing system 100 is achieved by one or more servers. For example, the product information processing system 100 is achieved by a database server to store information received from users and another server to operate and manage the shopping SNS.

The poster terminal 200 is used by a user (hereinafter referred to as “poster”) who makes a post containing information on items. Examples of the poster terminal 200 include smartphone and tablet computer. For example, the poster wears items bought on the e-commerce website and posts an image of the poster wearing the items on the shopping SNS.

The viewer terminal 300 is used by a user (hereinafter referred to as “viewer”) who views the post related to items. Examples of the viewer terminal 300 include smartphone and tablet computer. For example, the viewer views the post published on the shopping SNS.

The e-commerce server 400 is aimed at operating and managing the e-commerce website.

The network 500 is any wireless or wired communication network. Examples of the network 500 include the Internet, intranet, extranet, local area network (LAN), virtual private network (VPN), and telephone network.

2. Hardware Configuration of a Server

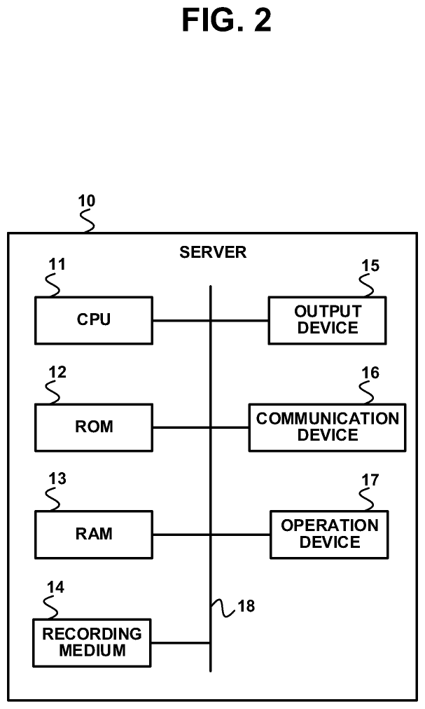

FIG. 2 is a block diagram illustrating a hardware configuration of a server 10 that achieves the product information processing system 100.

As illustrated in FIG. 2, the server 10 includes a central processing unit (CPU) 11, a read only memory (RAM) 12, a RAM 13, a recording medium 14, an output device 15, a communication device 16, and an operation device 17. These components are connected to each other via a bus 18.

The CPU 11 controls operations of the entire server 10, is connected to the individual components, and transmits or receives a control signal or data.

The ROM 12 stores operating programs and various types of data necessary for control of operations of the entire server 10.

The RAM 13 is intended to temporarily store data and program. The RAM 13 retains the program and data read from the recording medium 14 and data necessary for communication, for example.

The recording medium 14 includes a hard disk and a flash memory, for example, to record data to be processed in the product information processing system 100.

The output device 15 includes a display unit, such as liquid crystal display (LCD) and backlight, and a sound output unit, such as speaker. The output device 15 outputs data from the CPU 11 under the control of the CPU 11, for example.

The communication device 16 includes a communication interface to connect the server 10 to a computer communication network, such as the Internet. The communication device 16 enables communication with other information processing apparatuses, for example.

The operation device 17 includes an input unit, such as button, keyboard, touch panel, or microphone. The operation device 17 receives an operational input from a user of the server 10 and provides the CPU 11 with a signal corresponding to the received operational input.

3. Functional Configuration of the Product Information Processing System According to the Embodiment

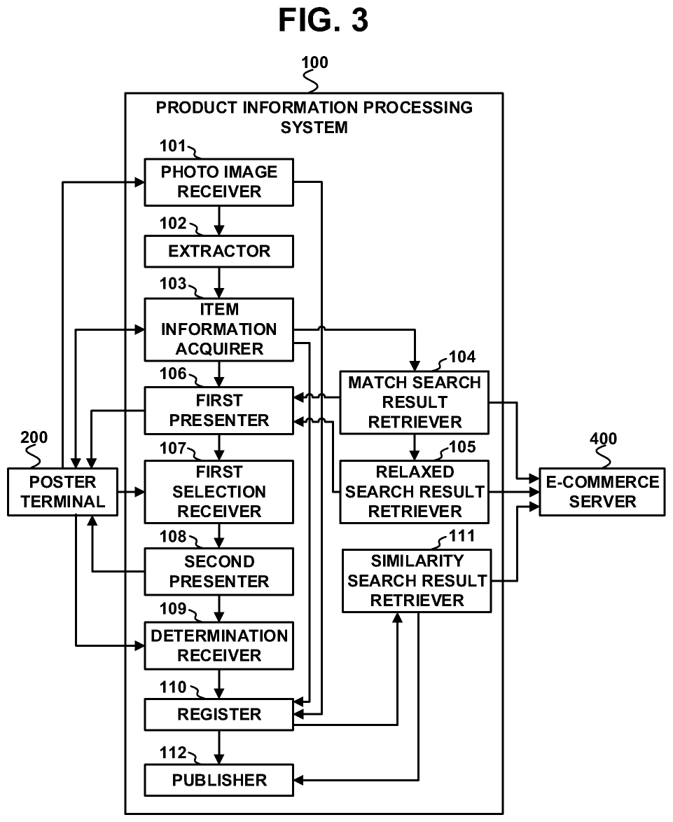

As illustrated in FIG. 3, the product information processing system 100 has a functional configuration including a photo image receiver 101, an extractor 102, an item information acquirer 103, a match search result retriever 104, a relaxed search result retriever 105, a first presenter 106, a first selection receiver 107, a second presenter 108, a determination receiver 109, a register 110, a similarity search result retriever 111, and a publisher 112. In this embodiment, the CPU 11 and the communication device 16 cooperate with each other to serve as the photo image receiver 101, the item information acquirer 103, the match search result retriever 104, the relaxed search result retriever 105, the first presenter 106, the first selection receiver 107, the second presenter 108, the determination receiver 109, and the similarity search result retriever 111. The CPU 11 serves as the extractor 102, the register 110, and the publisher 112.

The photo image receiver 101 receives a photo image that captures an item from a poster.

The item is a subject about which the poster is going to make a post on a shopping SNS, for example.

The photo image is an image containing the item. For example, the photo image is taken by the poster using the poster terminal 200 to capture the poster wearing clothing, shoes, bag that the poster has bought.

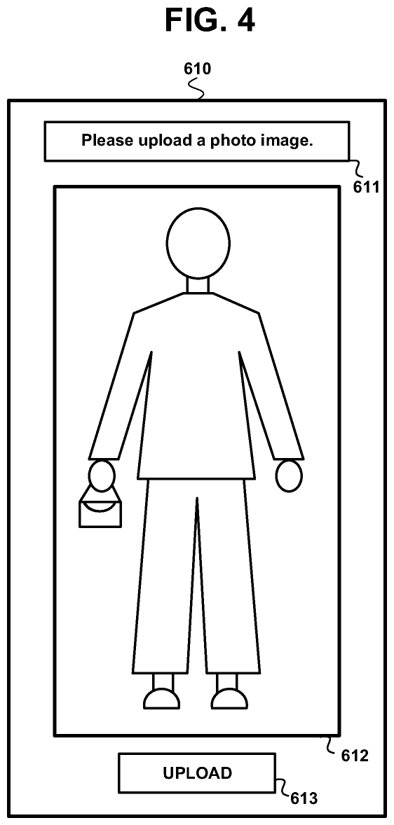

FIG. 4 illustrates a screen for uploading of a photo image by a poster X using the poster terminal 200. The image 610 in FIG. 4 is displayed on the screen of the poster terminal 200 in response to start of a posting task in the shopping SNS. The image 610 includes a message 611 to request uploading of a photo image, a photo image 612 that the poster X selects at the poster terminal 200, and a button 613 to upload the photo image. When the poster X taps the button 613, for example, the poster terminal 200 transmits the photo image 612 to the product information processing system 100, and the photo image receiver 101 then receives the transmitted photo image 612.

The extractor 102 extracts areas from the received photo image in which items of predetermined types are depicted.

The predetermined types indicate types of items on which information is registered in the e-commerce website. The predetermined types may also indicate types of items of which images can be automatically extracted from the photo image. The predetermined types can be arbitrarily designated by the administrator of the product information processing system 100. The following description assumes that the predetermined types include clothing, shoes, bags, caps/hats, accessories, and umbrellas.

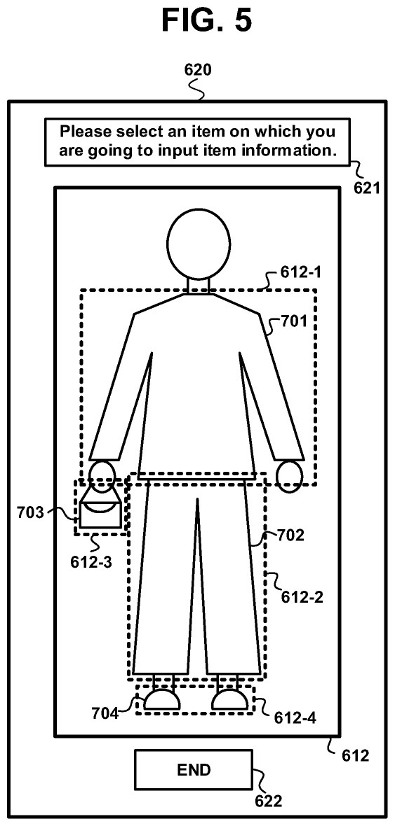

FIG. 5 illustrates exemplary areas extracted from the photo image 612 by the extractor 102. The image 620 in FIG. 5 is displayed on the screen of the poster terminal 200 after the uploading of the photo image. The image 620 includes a message 621 to request selection of an item to be subject to input of item information, which is described below, the photo image 612 provided with the indicators of extracted areas, and a button 622 to terminate the posting task. For example, the extractor 102 extracts areas 612-1, 612-2, 612-3, and 612-4 from the photo image 612, as illustrated in FIG. 5. The areas 612-1, 612-2, 612-3, and 612-4 respectively contain items 701, 702, 703, and 704 depicted therein.

The item information acquirer 103 acquires item information on the item depicted in each extracted area by guiding the poster to input the item information. For example, the item information acquirer 103 guides the poster to select one of multiple predetermined options and input a text and thereby acquires the item information.

The item information indicates information on an item. Examples of the item information include category, name of brand or manufacturer, color, size, and text information arbitrarily input by the poster about the item. Examples of the item information include information indicated by the options selected from the multiple predetermined options by the poster and the information indicated by the text input from the poster.

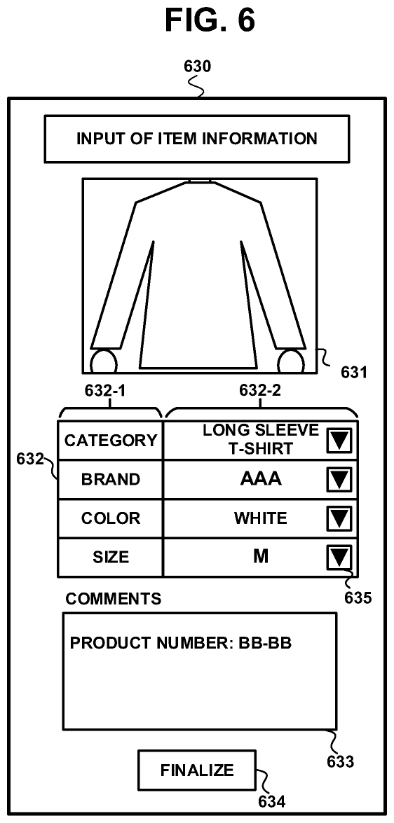

The following description is directed to an example in which the poster X inputs item information on the item 701 depicted in the area 612-1. When the poster X selects the area 612-1 by tapping or the like in FIG. 5, the image 630 designed for input of the item information in FIG. 6 is displayed on the screen of the poster terminal 200. The image 630 includes an image 631 of the area 612-1, a table 632 to show multiple predetermined options, a comment field 633, and a button 634 to finalize the input information. The table 632 contains entries 632-1 of item information, and predetermined options 632-2 associated with each entry. These predetermined options are displayed for each entry in response to selection of each of buttons 635.

For example, the item information acquirer 103 acquires information indicated by the options 632-2 selected by the poster X and information indicated by a text written in the comment field 633, as item information on the item 701 depicted in the area 612-1. That is, the item information acquirer 103 acquires the information indicating category “long sleeve T-shirt”, brand “AAA”, color “white”, and size “M”, and the text information “product number: BB-BB”, as the item information on the item depicted in the area 612-1.

The match search result retriever 104 retrieves a match search result through match searching in the items being sold on the e-commerce website on the basis of a match search condition including the acquired item information.

The match search condition is applied to match searching and includes the acquired item information. For example, the match search conditions contain category “long sleeve T-shirt”, brand “AAA”, color “white”, and size “M”, and text “product number: BB-BB”.

The match search result is a result retrieved through match searching on the basis of the match search condition. The match search result contains the item identical to the item 701 depicted in the area 612-1, for example.

For example, the match search result retriever 104 accesses to the e-commerce server 400, and searches the items being sold on the e-commerce website for an item that matches the category “long sleeve T-shirt”, the brand “AAA”, the color “white”, and the size “M”, and the text information “product number: BB-BB” contained in the match search conditions, and thereby retrieves a match search result. For example, the match search result retriever 104 retrieves items 1 to 4 as the match search result.

The relaxed search result retriever 105 generates a relaxed search condition by relaxing the match search condition, and then retrieves a relaxed search result through match searching in the items being sold on the e-commerce website on the basis of the generated relaxed search condition. For example, the relaxed search result retriever 105 generates the relaxed search conditions by relaxing the search conditions related to the selected options of the match search condition.

The relaxed search condition is applied to match searching and generated by relaxing the match search condition. For example, the search conditions generated by relaxing the match search conditions are search conditions excluding at least one of the match search conditions, or search conditions containing a broader concept of at least one of the match search conditions. Exemplary relaxed search conditions contain category “long sleeve T-shirt”, brand “AAA”, color “white”, and size “M”, generated by removing the text information “product number: BB-BB” from the match search conditions.

For example, the relaxed search conditions are generated by relaxing the search conditions related to the selected options of the match search conditions. The search conditions generated by relaxing the search conditions related to the selected options indicate search conditions generated by removing at least one of the selected options of multiple entries from the match search conditions, for example. Exemplary search conditions related to the selected options of the match search conditions contain category “long sleeve T-shirt”, brand “AAA”, color “white”, and size “M”, and exemplary relaxed search conditions contain category “long sleeve T-shirt”, brand “AAA”, color “white”, and text information “product number: BB-BB” generated by removing size “M” from the search conditions related to the selected options.

Alternatively, the search conditions generated by relaxing the search conditions related to the selected options contain broader concepts of the selected options, for example. Assuming that the category “long sleeve T-shirt” belongs to the upper category “tops” and the brand “AAA” belongs to the upper category “sport brand”, the relaxed search conditions contain category “tops”, brand “sport brand”, color “white”, size “M”, and text information “product number: BB-BB”, for example.

The relaxed search conditions may be a combination of search conditions excluding at least one of the match search conditions and search conditions containing a broader concept of at least one of the match search conditions. The following description assumes that the relaxed search conditions are category “tops”, brand “sport brand”, color “white”, and size “M”.

The relaxed search result is a result retrieved through match searching on the basis of the relaxed search conditions. The relaxed search result contains the item identical to the item 701 depicted in the area 612-1 and similar items, for example.

For example, the relaxed search result retriever 105 accesses to the e-commerce server 400, and searches the items being sold on the e-commerce website for an item that matches the category “tops”, the brand “sport brand”, the color “white”, and the size “M” contained in the relaxed search conditions, and thereby retrieves the relaxed search result. For example, the relaxed search result retriever 105 retrieves items 5 to 8 as the relaxed search result.

The first presenter 106 presents a list in which the items contained in the retrieved match search result are arranged prior to the items contained in the retrieved relaxed search result, to the poster.

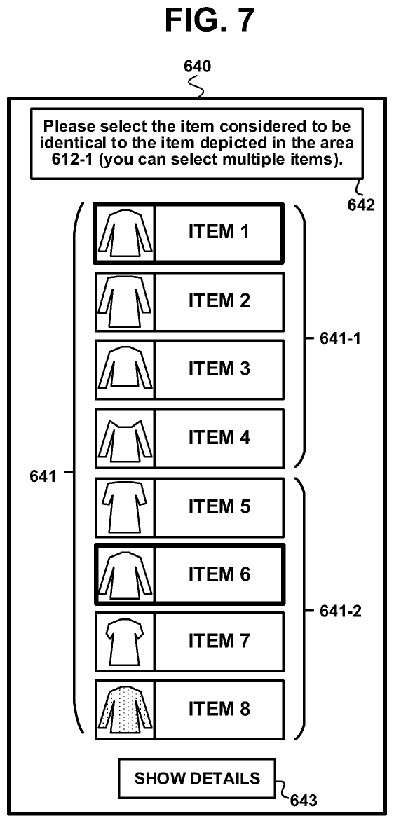

FIG. 7 illustrates an exemplary list presented by the first presenter 106. The image 640 in FIG. 7 is displayed on the screen of the poster terminal 200. The image 640 includes a list 641 of items, a message 642 to request selection of one or more items that are likely to be identical to the item to be contained in the post from the list 641, and a button 643 to check out the details of the items selected from the list 641. The first presenter 106 presents, to the poster X, the list 641, in which the items 1 to 4 (list 641-1) contained in the match search result are arranged prior to the items 5 to 8 (list 641-2) contained in the relaxed search result, as illustrated in FIG. 7.

The first selection receiver 107 receives, from the poster, selection of one or more candidate items from the items contained in the list.

The candidate items are items that can be associated with the item to be contained in the post. The candidate items can be regarded as items that are determined by the poster, who reads the message 642 as illustrated in FIG. 7, to be likely identical to the item to be contained in the post.

For example, when the poster X selects the items 1 and 6 as the items that are likely to be identical to the item 701 to be contained in the post, the items 1 and 6 contained in the list are highlighted as illustrated in FIG. 7. When the poster X subsequently taps the button 643, for example, the first selection receiver 107 receives selection of the items 1 and 6 as the candidate items.

The second presenter 108 presents the details of the selected one or more candidate items to the poster.

The details of the candidate items indicate sales information published on the e-commerce website, for example.

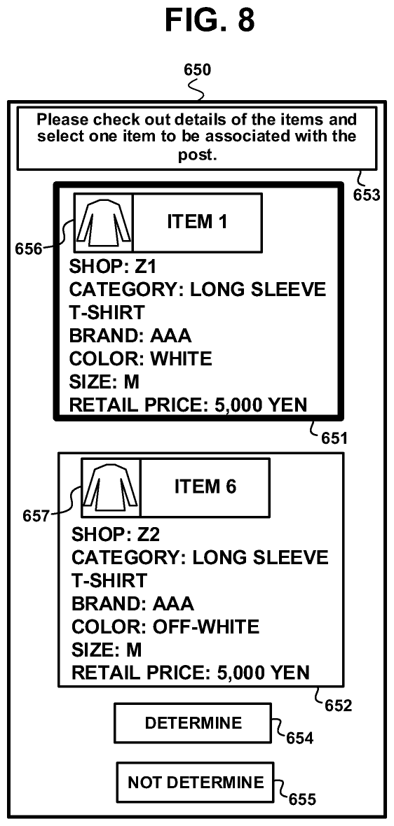

FIG. 8 illustrates a screen for displaying the details of the candidate items presented by the second presenter 108. The image 650 in FIG. 8 is displayed on the screen of the poster terminal 200. The image 650 includes sales information 651 and 652, a message 653 to request selection of any one item associated with the item to be contained in the post from the candidate items, a button 654 to determine selection of the item from the candidate items, and a button 655 to express no determination of selection of any item from the candidate items. The second presenter 108 presents the sales information 651 and 652 on the candidate items 1 and 6 to the poster X, as illustrated in FIG. 8.

The determination receiver 109 receives, from the poster, the determination of any one item among the candidate items that have been selected to present the details. When the determination receiver 109 receives the determination of any one item, the item related to the received determination is determined by the poster as the item associated with the item to be contained in the post, that is, the item related to the received determination can be regarded as the item determined to be identical to the item to be contained in the post. In contrast, when the determination receiver 109 receives no determination of any one item, the one or more candidate items that have been selected to present the details can be regarded as items that are determined by the poster to be similar but not identical to the item to be contained in the post. Since none of the candidate items that have been selected and of which the details are viewed is determined to be identical to the item to be contained in the post, the items contained in the match search result are considered to not include an item identical to the item to be contained in the post. This fact implies that the item that the poster is going to post may be unavailable on the e-commerce website.

For example, when the poster X determines the item 1 to be identical to the item 701 to be contained in the post after checking out the presented sales information, selects the sales information 651 on the item 1, and taps the button 654, for example, then the determination receiver 109 receives determination of selection of the item 1. In contrast, when the poster X determines both of the items 1 and 6 to be different from the item 701 and taps the button 655, for example, then the determination receiver 109 determines no reception of determination of any one item.

The register 110 registers the post containing the received photo image in association with (i) the one or more candidate items that have been selected and of which the details are viewed by the poster and (ii) the acquired item information. When the determination receiver 109 receives the determination of any one item from the poster, the register 110 registers the sales information on this item of which the determination is received, in association with the post.

For example, the register 110 causes the post containing the photo image 612 to be stored into the recording medium 14 such that the information on the candidate items 1 and 6 and the item information indicating the contents selected and filled out in FIG. 5 are associated with the post containing the photo image 612. When the determination receiver 109 receives the determination of selection of the item 1, the register 110 further causes the sales information 651 on the item 1 to be stored into the recording medium 14 in association with the post containing the photo image 612.

The publisher 112 publishes the registered post.

For example, when the register 110 causes the post containing the photo image 612 to be stored into the recording medium 14 in association with the information on the candidate items 1 and 6, the item information, and the sales information 651, then the image 620 in FIG. 5 is displayed on the screen of the poster terminal 200. Then, when the poster X selects the button 622 to terminate the posting task, the publisher 112 causes the screen of the poster terminal 200 to display an image, which is not illustrated, to ask the poster X whether to publish the post. The publisher 112 publishes the post when the poster X makes a manipulation to publish the post.

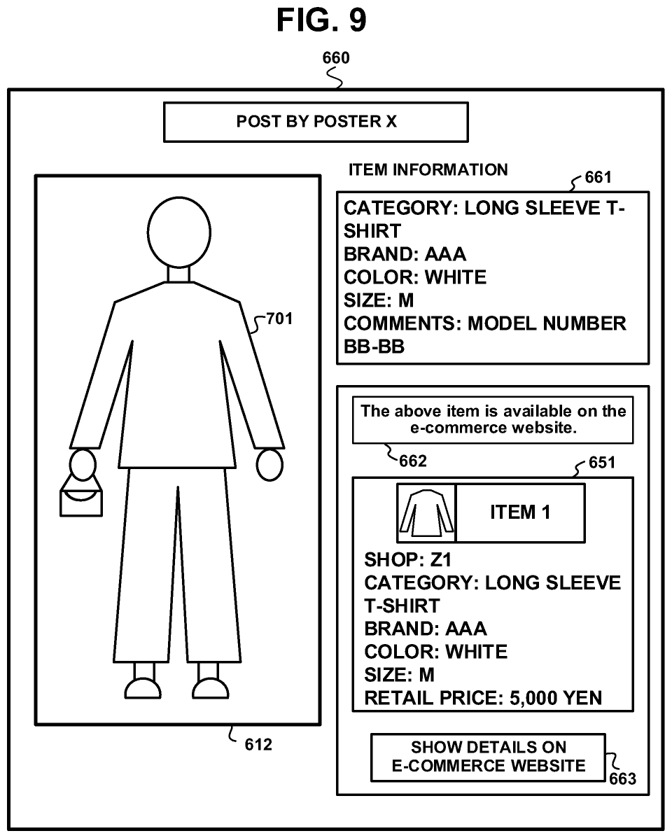

FIG. 9 illustrates a screen for displaying an exemplary post, to which sales information on the item is associated by the register 110, published by the publisher 112. The image 660 in FIG. 9 is displayed on the screen of the viewer terminal 300. The image 660 includes the photo image 612, item information 661 acquired on the item 701, a message 662 to recite that the item determined by the poster to be identical to the item 701 is available on the e-commerce website, the sales information 651 on the item 1, and a button 663 to check out the details of the item 1 on the e-commerce website. When a viewer Y selects the button 663 by tapping or the like, the screen of the viewer terminal 300 changes from the image 660 in FIG. 9 to the page for selling the item 1 on the e-commerce website. The viewer Y can thus buy the item 1 on the e-commerce website.

In contrast, when the determination receiver 109 receives no determination of any one item, the register 110 does not associate the sales information with the post containing the photo image 612.

When no sales information is associated with the registered post, or when sales information is associated with the registered post but the item indicated by the sales information is sold out on the e-commerce website, the similarity search result retriever 111 retrieves a similarity search result, through similarity searching in the items now being sold on the e-commerce website on the basis of the registered candidate items and the registered item information.

The case where no sales information is associated with the registered post indicates the case where the determination receiver 109 receives no determination of any one item, that is, the case where the item that the poster is going to post is not being sold on the e-commerce website.

The similarity search result is a result retrieved through similarity searching on the basis of the registered one or more candidate items and the registered item information. The registered one or more candidate items indicate the candidate items that have been selected by the poster to present the details and determined to be similar but not identical to the item to be contained in the post. The similarity search result contains the items 1 and 6, which the poster X determines to be similar but not identical to the item 701 to be contained in the post, and similar items similar to the item 701 depicted in the area 612-1, for example.

For example, when no sales information is registered in association with the post containing the photo image 612, or when sales information is registered but the item 1 indicated by the sales information is sold out on the e-commerce website, the similarity search result retriever 111 accesses to the e-commerce server 400 and executes similarity searching.

In one example, the similarity search result retriever 111 executes similarity searching after removing information on the selected options from the registered item information.

For example, the similarity search result retriever 111 removes the information indicating category “long sleeve T-shirt”, brand “AAA”, color “white”, and size “M” from the item information 661, and then executes similarity searching in the items now being sold on the e-commerce website on the basis of the information on the items 1 and 6 and the text information “product number: BB-BB”.

Alternatively, the similarity search result retriever 111 executes similarity searching after adding information on options similar to the selected options to the registered item information.

For example, the similarity search result retriever 111 executes similarity searching in the items now being sold on the e-commerce website, on the basis of the information on the items 1 and 6, the item information 661, and the information indicating the category “short sleeve T-shirt” similar to the information indicating the category “long sleeve T-shirt”.

The similarity search result retriever 111 may also execute similarity searching further on the basis of an image of the area extracted from the photo image and photo image of the registered one or more candidate items.

For example, the similarity search result retriever 111 executes similarity searching in the items now being sold on the e-commerce website, on the basis of the image 631 of the area 612-1 (FIG. 6) extracted from the photo image 612 and photo images 656 and 657 (FIG. 8) of the items 1 and 6.

For example, the similarity search result retriever 111 executes similarity searching and thus retrieves items 9 to 12 as a similarity search result.

When the similarity search result retriever 111 retrieves the similarity search result, the publisher 112 publishes the sales information on an item contained in the retrieved similarity search result as well as the post.

For example, when the similarity search result retrieved by the similarity search result retriever 111 contains the items 9 to 12, the publisher 112 publishes sales information on the item 9 at the top of the search order.

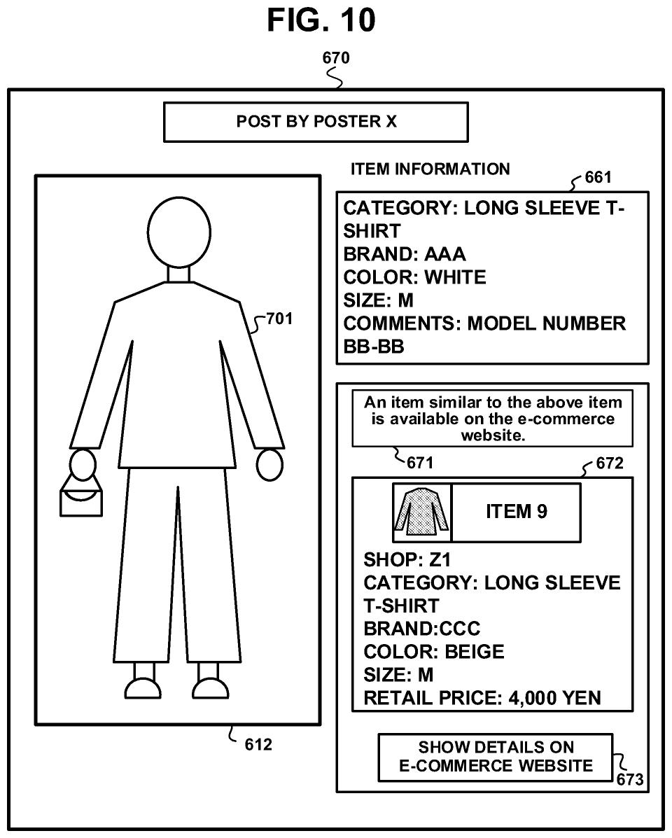

FIG. 10 illustrates a screen for displaying another exemplary post containing sales information on an item contained in the similarity search result published by the publisher 112. The image 670 in FIG. 10 is displayed on the screen of the viewer terminal 300. The image 670 includes the photo image 612, the item information 661 acquired on the item 701, a message 671 to recite that an item similar to the item 701 is available on the e-commerce website, sales information 672 on the item 9, which is a similar item similar to the item 701, and a button 673 to check out the details of the item 9 on the e-commerce website. When the viewer Y selects the button 673 by tapping or the like, the screen of the viewer terminal 300 changes from the image 670 in FIG. 10 to the page for selling the item 9 on the e-commerce website. The viewer Y can thus buy the item 9 on the e-commerce website.

Although the sales information on the item 701 in the area 612-1 is published in the above-described example, the same processing is also executed for each of the items 702, 703, and 704 in the areas 612-2, 612-3, and 612-4, in accordance with selection by the poster X. For example, after the determination receiver 109 receives determination of selection of the item 1 or determination of no selection of any item and the register 110 or the similarity search result retriever 111 executes the own processing, the screen changes back to FIG. 5 to receive selection of another item from the poster X. The product information processing system 100 then executes a posting task like that for the item 701.

4. Operation of the Product Information Processing System According to the Embodiment

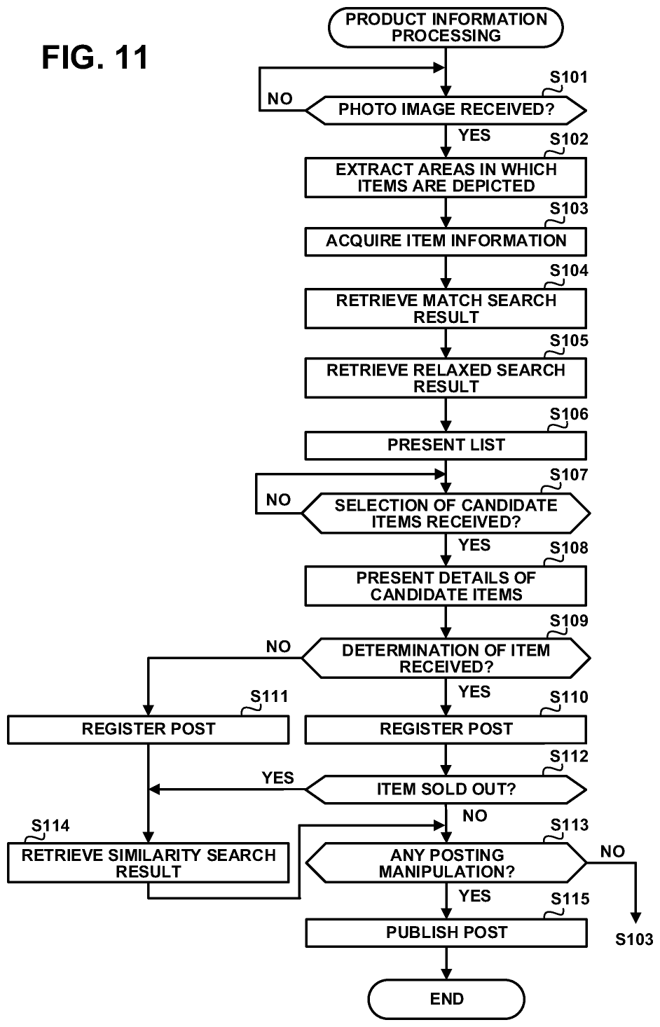

An operation of the product information processing system 100 according to the embodiment is described below with reference to FIG. 11. For example, in response to reception of an instruction to start a posting task from the poster, the product information processing system 100 starts product information processing illustrated in FIG. 11.

The photo image receiver 101 determines whether a photo image that captures an item is received from the poster (Step S101). When the photo image receiver 101 determines that the photo image is received (Step S101; YES), the extractor 102 extracts areas from the received photo image in which items of the predetermined types are depicted (Step S102). In contrast, when the photo image receiver 101 determines that no photo image is received (Step S101; NO), the photo image receiver 101 waits until reception.

For example, when the photo image receiver 101 receives the photo image 612 from the poster X, the extractor 102 extracts the areas 612-1, 612-2, 612-3, and 612-4 from the photo image 612, in which items of the predetermined types (clothing, shoes, and bag) are depicted, as illustrated in FIG. 5. In contrast, when the photo image receiver 101 determines that no photo image is received, the photo image receiver 101 waits until reception.

The item information acquirer 103 acquires item information on the item depicted in each of the extracted areas (Step S103).

For example, when the poster X selects the area 612-1 by tapping or the like in FIG. 5, the image 630 designed for input of the item information in FIG. 6 is displayed on the screen of the poster terminal 200. The item information acquirer 103 then acquires information on the options 632-2 selected by the poster X, and information on a text written in the comment field 633, as the item information on the item 701 depicted in the area 612-1.

The match search result retriever 104 then retrieves a match search result through match searching in items being sold on the e-commerce website on the basis of match search conditions including the acquired item information (Step S104).

For example, the match search result retriever 104 accesses to the e-commerce server 400, searches the items being sold on the e-commerce website for an item that matches the category “long sleeve T-shirt”, the brand “AAA”, the color “white”, and the size “M”, and the text information “product number: BB-BB” contained in the match search conditions, and thereby retrieves the items 1 to 4 as a match search result.

The relaxed search result retriever 105 retrieves a relaxed search result through match searching in items being sold on the e-commerce website on the basis of relaxed search conditions (Step S105).

For example, the relaxed search result retriever 105 accesses to the e-commerce server 400, searches the items being sold on the e-commerce website for an item that matches the category “tops”, the brand “sport brand”, the color “white”, and the size “M” contained in the relaxed search conditions, and thereby retrieves the items 5 to 8 as a relaxed search result.

The first presenter 106 then presents a list in which the items contained in the match search result are arranged prior to the items contained in the relaxed search result, to the poster (Step S106).

For example, the first presenter 106 presents, to the poster X, the list 641 in which the items 1 to 4 contained in the match search result are arranged prior to the items 5 to 8 contained in the relaxed search result, as illustrated in FIG. 7.

The first selection receiver 107 then determines whether selection of one or more candidate items from the items contained in the list is received from the poster (Step S107). When the first selection receiver 107 determines that selection of one or more candidate items is received (Step S107; YES), the second presenter 108 presents the details of the selected one or more candidate items to the poster (Step S108). In contrast, when the first selection receiver 107 determines that no selection of one or more candidate items is received (Step S107; NO), the first selection receiver 107 waits until reception.

For example, when the poster X selects the items 1 and 6 and taps the button 643 in FIG. 7, then the first selection receiver 107 receives selection of the items 1 and 6 as the candidate items. The second presenter 108 then presents the sales information 651 and 652 on the candidate items 1 and 6 to the poster X, as illustrated in FIG. 8. In contrast, when the poster X selects no item in FIG. 7, the first selection receiver 107 determines that no selection is received and waits until reception.

The determination receiver 109 determines whether determination of any one item among the candidate items that have been selected to present the details is received from the poster (Step S109). When the determination receiver 109 determines that determination of any one item is received (Step S109; YES), the register 110 registers the post containing the received photo image such that the one or more candidate items that have been selected and of which the details are viewed by the poster, the acquired item information, and sales information on the one item of which the determination is received are associated with this post (Step S110). In contrast, when the determination receiver 109 determines that no determination of any one item is received (Step S109; NO), the register 110 registers the post containing the received photo image such that the one or more candidate items that have been selected and of which the details are viewed by the poster and the acquired item information are associated with this post (Step S111).

For example, when the poster X selects the sales information 651 on the item 1 and taps the button 654, the determination receiver 109 receives determination of selection of the item 1. The register 110 then causes the post containing the photo image 612 to be stored into the recording medium 14 such that the candidate items 1 and 6, the item information indicating the contents selected and filled out in FIG. 5, and the sales information 651 on the item 1 are associated with the post containing the photo image 612. In contrast, when the poster X taps the button 655, for example, then the determination receiver 109 determines that no determination of any one item is received, and the register 110 causes the post containing the photo image 612 to be stored into the recording medium 14 such that the candidate items 1 and 6 and the item information indicating the contents selected and filled out in FIG. 5 are associated with the post containing the photo image 612.

After Step S110, the register 110 determines whether the item indicated by the sales information associated with the registered post is sold out on the e-commerce website (Step S112). When the register 110 determines that the item indicated by the sales information is sold out (Step S112; YES), the process goes to Step S114. In contrast, when the register 110 determines that the item indicated by the sales information is not sold out (Step S112; NO), the publisher 112 determines whether the poster performs a manipulation for publishing the post (Step S113). When the publisher 112 determines that the poster performs the manipulation for publishing the post (Step S113; YES), the publisher 112 publishes the registered post (Step S115). In contrast, when the publisher 112 determines that the poster does not perform the manipulation for publishing the post (Step S113; NO), the process returns to Step S103.

For example, when the register 110 determines that the item 1 is sold out on the e-commerce website, the process goes to Step S114. In contrast, when the register 110 determines that the item 1 is not sold out on the e-commerce website, the publisher 112 determines whether an instruction to publish the post is received from the poster X. When the publisher 112 determines that the instruction to publish the post is received, the publisher 112 publishes the registered post, as illustrated in FIG. 9. In contrast, when the publisher 112 determines that no instruction to publish the post is received, the process returns to Step S103.

After Step S111, and when the register 110 determines that the item indicated by the sales information is sold out (Step S112; YES), the similarity search result retriever 111 retrieves a similarity search result through similarity searching in the items now being sold on the e-commerce website on the basis of the registered one or more candidate items and the registered item information (Step S114). The process then goes to Step S113.

For example, the similarity search result retriever 111 retrieves the items 9 to 12 as the similarity search result through similarity searching in the items now being sold on the e-commerce website on the basis of the information on the items 1 and 6, the item information 661, and the information indicating the category “short sleeve T-shirt” similar to the information indicating the category “long sleeve T-shirt”. The process then goes to Step S113. When the publisher 112 determines that the instruction to publish the post is received, the publisher 112 publishes a post containing the sales information 672 on the item 9 at the top of the similarity search result, as illustrated in FIG. 10.

In this embodiment, similarity searching is executed in the items on the e-commerce website on the basis of the item information acquired in accordance with the input from the poster, and the items that the poster determines to be similar but not identical to the item to be contained in the post in a posting task. This configuration can improve the accuracy of searching for similar items similar to the item to be contained in the post without increasing the burden on the poster. The configuration can inform a viewer of the sales information on items retrieved through similarity searching with high accuracy in the case where the item to be contained in the post is sold out or unavailable on the e-commerce website.

5. Modification

Although an embodiment of the present disclosure is described above, various types of modification and application are available in practice of the present disclosure.

Although the product information processing system 100 and the e-commerce server 400 are connected so as to be communicable with each other in the above embodiment, this configuration is a mere example. The product information processing system 100 may include the e-commerce server 400.

Although the item information acquirer 103 acquires item information on an item depicted in an extracted area by guiding the poster to select one of the multiple predetermined options and input a text in the above embodiment, the item information acquirer 103 may also automatically acquire some pieces of the item information. For example, the item information acquirer 103 may cause an image recognition AI to extract the areas in which items of the predetermined types are depicted and acquire the types of items depicted in the individual areas, from the received photo image.

Although the image 640 in FIG. 7 includes the button 643 to check out the details of the items selected from the list 641 in the above embodiment, this button 643 may be omitted. In this case, when the poster selects a single item from the list, an image is displayed on the screen of the poster terminal 200, which includes sales information on the selected single item, a button to determine selection of the item on which the sales information is viewed, and a button to express no determination of selection of any item.

Although the above embodiment is directed to an example in which similarity searching is executed using the registered one or more candidate items (candidate items that have been selected by the poster to present the details), the one or more candidate items referenced in similarity searching may be further narrowed down in accordance with selection of the poster.

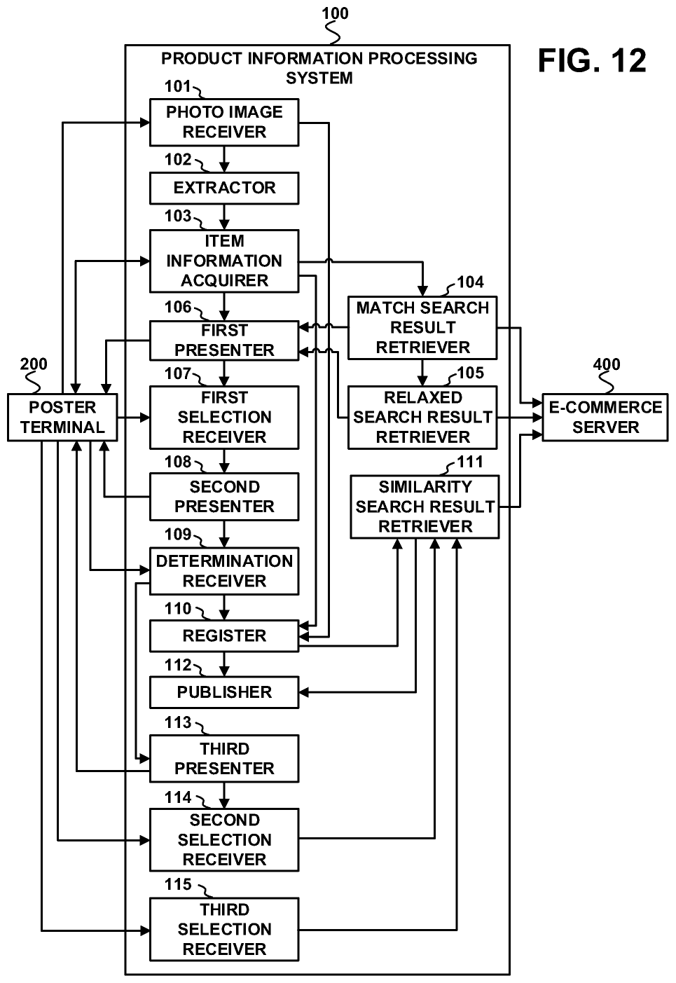

FIG. 12 illustrates a functional configuration of the product information processing system 100 configured to narrow down candidate items. The product information processing system 100 has a functional configuration including, in addition to the components illustrated in FIG. 3, a third presenter 113, a second selection receiver 114, and a third selection receiver 115. The CPU 11 and the communication device 16 cooperate with each other to serve as the third presenter 113, the second selection receiver 114, and the third selection receiver 115.

When the determination receiver 109 receives no determination of any one item from the poster, the third presenter 113 presents a catalog of one or more candidate items that have been selected to present the details to the poster.

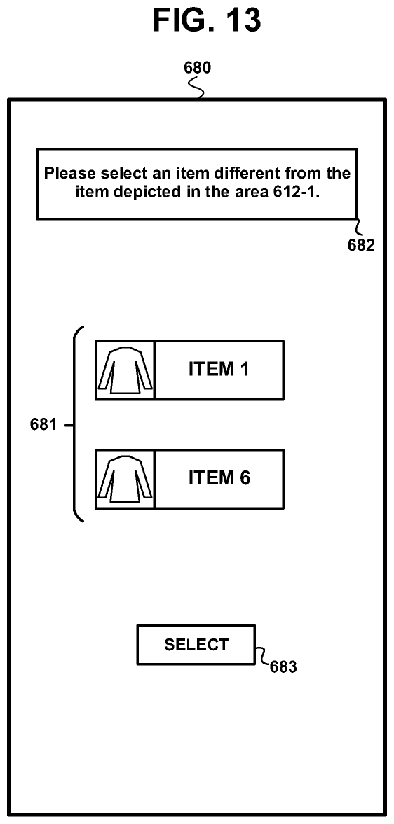

FIG. 13 illustrates a screen including the catalog of the candidate items that have been selected to present the details, which is presented by the third presenter 113. The image 680 in FIG. 13 is displayed on the screen of the poster terminal 200, after selection of the button 655 in FIG. 8. The image 680 includes a catalog 681 of the candidate items that have been selected by the poster X to present the details to the poster X, a message 682 to request selection of an item different from the item depicted in the area 612-1 among the candidate items contained in the catalog 681, and a button 683 to express selection.

The second selection receiver 114 receives, from the poster, an item different from the item depicted in the area among the one or more candidate items contained in the catalog.

For example, when the poster X selects the item 6 and taps the button 683, the second selection receiver 114 receives selection of the item 6 as the item different from the item depicted in the area 612-1.

The similarity search result retriever 111 removes the selected different item from the registered one or more candidate items, and then executes similarity searching.

For example, the similarity search result retriever 111 executes similarity searching in the items now being sold on the e-commerce website, on the basis of the information on the item 1, the item information 661, and the information indicating the category “short sleeve T-shirt” similar to the information indicating the category “long sleeve T-shirt”.

Alternatively, the third selection receiver 115 receives, from the poster, selection of an item similar to the item depicted in the area among the one or more candidate items contained in the catalog.

For example, the third presenter 113 presents a message to request selection of an item similar to the item depicted in the area 612-1 from the catalog 681 in FIG. 13, instead of the message 682. Then, when the poster X selects the item 6 and taps the button 683, for example, the second selection receiver 114 receives selection of the item 6 as the item similar to the item depicted in the area 612-1.

The similarity search result retriever 111 executes similarity searching on the basis of the selected similar item, instead of the registered one or more candidate items.

For example, the similarity search result retriever 111 executes similarity searching in the items now being sold on the e-commerce website, on the basis of the information on the item 6, the item information 661, and the information indicating the category “short sleeve T-shirt” similar to the information indicating the category “long sleeve T-shirt”.

This configuration can narrow down the conditions applied to similarity searching in accordance with the input from the poster, and can therefore improve the accuracy of searching for similar items similar to the item to be contained in the post.

The foregoing describes some example embodiments for explanatory purposes.

Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can provide a product information processing system, a product information processing method, and a recording medium that can facilitate registration of appropriate similar items in a post related to an item.

What is claimed is:

1. A product information processing system, comprising:
at least one memory that stores program code; and
at least one processor configured to read the program code and operate in accordance with the program code, wherein
the program code includes:
photo image reception code configured to cause the at least one processor to receive a photo image that captures an item from a poster;
extraction code configured to cause the at least one processor to extract an area, in which an item of a predetermined type is depicted, from the received photo image;
item information acquisition code configured to cause the at least one processor to acquire item information on the item depicted in the extracted area by guiding the poster to input the item information;
match search result retrieval code configured to cause the at least one processor to retrieve a match search result through match searching in items being sold on an e-commerce website on basis of a match search condition including the acquired item information;
relaxed search result retrieval code configured to cause the at least one processor to generate a relaxed search condition by relaxing the match search condition, and retrieve a relaxed search result through match searching in the items being sold on the e-commerce website on basis of the generated relaxed search condition;
first presentation code configured to cause the at least one processor to present a list, in which items contained in the retrieved match search result are arranged prior to items contained in the retrieved relaxed search result, to the poster;
first selection reception code configured to cause the at least one processor to receive, from the poster, selection of at least one candidate item from the items contained in the list;
second presentation code configured to cause the at least one processor to present details of the selected at least one candidate item to the poster;
determination reception code configured to cause the at least one processor to receive, from the poster, determination of any one item among the at least one candidate item that has been selected to present the details;
registration code configured to cause the at least one processor to register a post containing the received photo image in association with (i) the at least one candidate item that has been selected and of which the details are viewed by the poster and (ii) the acquired item information, the registration code being configured to cause, when the at least one processor according to the determination reception code receives the determination of any one item from the poster, the at least one processor to register sales information on the item of which the determination is received in association with the post;
publication code configured to cause the at least one processor to publish the registered post; and
similarity search result retrieval code, and
when no sales information is associated with the registered post, or when sales information is associated with the registered post but an item indicated by the sales information is sold out on the e-commerce website,
the similarity search result retrieval code is configured to cause the at least one processor to retrieve a similarity search result through similarity searching in the items now being sold on the e-commerce website on basis of the registered at least one candidate item and the registered item information, and
the publication code is configured to cause the at least one processor to publish sales information on an item contained in the retrieved similarity search result as well as the post.

2. The product information processing system according to claim 1, wherein
the item information acquisition code is configured to cause the at least one processor to acquire the item information by guiding the poster to select one of multiple predetermined options and input a text, and
the relaxed search result retrieval code is configured to cause the at least one processor to generate the relaxed search condition by relaxing a search condition related to the selected option of the match search condition.

3. The product information processing system according to claim 2, wherein the similarity search result retrieval code is configured to cause the at least one processor to remove information on the selected option from the registered item information and then execute similarity searching.

4. The product information processing system according to claim 2, wherein the similarity search result retrieval code is configured to cause the at least one processor to add information on an option similar to the selected option to the registered item information and then execute similarity searching.

5. The product information processing system according to claim 1, wherein
the program code further comprises:
third presentation code configured to cause the at least one processor to present, to the poster, a catalog of the at least one candidate item that has been selected to present the details, when the at least one processor according to the determination reception code receives no determination of any one item from the poster; and
second selection reception code configured to cause the at least one processor to receive, from the poster, selection of an item different from the item depicted in the area among the at least one candidate item contained in the catalog, and
the similarity search result retrieval code is configured to cause the at least one processor to remove the selected different item from the registered at least one candidate item and then execute similarity searching.

6. The product information processing system according to claim 1, wherein
the program code further comprises:
third presentation code configured to cause the at least one processor to present, to the poster, a catalog of the at least one candidate item that has been selected to present the details, when the at least one processor according to the determination reception code receives no determination of any one item from the poster; and
third selection reception code configured to cause the at least one processor to receive, from the poster, selection of an item similar to the item depicted in the area among the at least one candidate item contained in the catalog, and
the similarity search result retrieval code is configured to cause the at least one processor to execute similarity searching on basis of the selected similar item instead of the registered at least one candidate item.

7. The product information processing system according to claim 1, wherein the similarity search result retrieval code is configured to cause the at least one processor to execute similarity searching further on basis of an image of the area extracted from the photo image and a photo image of the registered at least one candidate item.

8. A product information processing method to be executed in a product information processing system, the product information processing method comprising:
receiving a photo image that captures an item from a poster;
extracting an area, in which an item of a predetermined type is depicted, from the received photo image;
acquiring item information on the item depicted in the extracted area by guiding the poster to input the item information;
retrieving a match search result through match searching in items being sold on an e-commerce website on basis of a match search condition including the acquired item information;
generating a relaxed search condition by relaxing the match search condition, and retrieving a relaxed search result through match searching in the items being sold on the e-commerce website on basis of the generated relaxed search condition;
presenting a list, in which items contained in the retrieved match search result are arranged prior to items contained in the retrieved relaxed search result, to the poster;
receiving, from the poster, selection of at least one candidate item from the items contained in the list;
presenting details of the selected at least one candidate item to the poster;
receiving, from the poster, determination of any one item among the at least one candidate item that has been selected to present the details;
registering a post containing the received photo image in association with (i) the at least one candidate item that has been selected and of which the details are viewed by the poster and (ii) the acquired item information, and when receiving the determination of any one item from the poster, registering sales information on the item of which the determination is received in association with the post; and
publishing the registered post,
in the product information processing system, wherein
when no sales information is associated with the registered post, or when sales information is associated with the registered post but an item indicated by the sales information is sold out on the e-commerce website, the product information processing system
retrieves a similarity search result through similarity searching in the items now being sold on the e-commerce website on basis of the registered at least one candidate item and the registered item information, and
publishes sales information on an item contained in the retrieved similarity search result as well as the post.

9. A non-transitory computer-readable recording medium storing a program that causes a computer to:
receive a photo image that captures an item from a poster;
extract an area, in which an item of a predetermined type is depicted, from the received photo image;
acquire item information on the item depicted in the extracted area by guiding the poster to input the item information;
retrieve a match search result through match searching in items being sold on an e-commerce website on basis of a match search condition including the acquired item information;
generate a relaxed search condition by relaxing the match search condition, and retrieve a relaxed search result through match searching in the items being sold on the e-commerce website on basis of the generated relaxed search condition;
present a list, in which items contained in the retrieved match search result are arranged prior to items contained in the retrieved relaxed search result, to the poster;
receive, from the poster, selection of at least one candidate item from the items contained in the list;
present details of the selected at least one candidate item to the poster;
receive, from the poster, determination of any one item among the at least one candidate item that has been selected to present the details;
register a post containing the received photo image in association with (i) the at least one candidate item that has been selected and of which the details are viewed by the poster and (ii) the acquired item information, and when receiving the determination of any one item from the poster, register sales information on the item of which the determination is received in association with the post; and
publish the registered post, wherein
when no sales information is associated with the registered post, or when sales information is associated with the registered post but an item indicated by the sales information is sold out on the e-commerce website, the program causes the computer to
retrieve a similarity search result through similarity searching in the items now being sold on the e-commerce website on basis of the registered at least one candidate item and the registered item information, and
publish sales information on an item contained in the retrieved similarity search result as well as the post.
